(19) United States
(12) Patent Application Publication
(10) Pub. No.: US 2023/0028877 A1
(43) Pub. Date: Jan. 26, 2023

(54) WATER-INDICATING PASTE COMPOSITIONS

(71) Applicant: Arkema France, Colombes (FR)

(72) Inventors: Endrit Shurdha, Exton, PA (US); Thomas W. Hazell, Exton, PA (US)

(21) Appl. No.: 17/787,413

(22) PCT Filed: Dec. 15, 2020
(86) PCT No.: PCT/IB2020/001082

§ 371 Date: Jun. 20, 2022

Related U.S. Application Data
(60) Provisional application No. 62/952,511, filed on Dec. 23, 2019.

(51) Int. Cl. G01N 31/22; G01N 21/80

(52) U.S. Cl. CPC G01N 31/222; G01N 21/80

(57) ABSTRACT

A visual indicating paste composition is provided which is capable of producing a detectable color change upon contact with an aqueous liquid. The paste composition includes: an indicator dye capable of changing color in the pH range between about 3 and about 11; an inorganic base capable of being converted to a more basic substance upon reaction with water; a liquid carrier (such as a polyalkylene glycol carrier); optionally, a gelling agent such as silica gel; and a proton donating compound such as a carboxylic acid or organosulfonic acid. When applied to a measuring probe, the paste composition is particularly adapted for detecting the water level in the bottom of tanks and delivery systems containing a fuel such as gasoline by producing a clear detectable color change without bleeding or run-off upon contact with an aqueous liquid. The paste composition exhibits long shelf life and improved water tolerance.

### FIELD OF THE INVENTION

The present invention relates to stabilized visual indicating paste compositions and to the utilization of the same to detect the presence, and particularly the level, of aqueous liquids when admixed with hydrocarbons, such as gasoline, oil or other fuel and petroleum fractions.

More particularly, the present invention is concerned with stabilized visual indicating paste compositions which are capable of undergoing a change in color upon contact with aqueous liquids which may be present in minor amounts, generally as a separate phase, in hydrocarbon storage tanks, delivery vehicles, distribution systems, and the like. The compositions of the invention are particularly adapted for use in determining the water level in the bottom of gasoline storage and transportation tanks to determine the amount of water resting in the tank partially filled with the hydrocarbon, and when the water contains oxygenated blending components, such as ethers and alcohols.

### DISCUSSION OF THE RELATED ART

Paste compositions capable of detecting the level or presence of water have been disclosed in the prior art.

For example, in U.S. Pat. No. 4,699,885 there is disclosed a visual indicating paste composition for producing a detectable color change upon contact with an aqueous liquid comprising a water soluble indicator dye capable of changing color in the pH range between about 7 and 11 and an insoluble, inorganic base in the form of a caustic powder dispersed in a liquid carrier capable of absorbing water but which is not rapidly leached by water or hydrocarbon. Chinese Published Application No. CN103173206 discloses similar paste compositions. It has been found, however, that the water indicating paste disclosed in said applications may turn color during storage due to the introduction of trace quantities of water originating from one or more sources. Hence, water may penetrate the paste should humid conditions exist during manufacture or storage of the paste or water may be absorbed by the paste while opening the container during each application of the paste by the user. In addition, water may be introduced with the ingredients, such as liquid carriers, employed in formulation of the paste.

U.S. Pat. No. 4,717,671 describes a visual indicating paste composition similar to the compositions disclosed in U.S. Pat. No. 4,699,885 which achieves a longer shelf life and improved water tolerance through the inclusion of a moisture inhibiting amount of a boron-containing compound such as a borate ester which is miscible with or soluble in the polyalkylene glycol carrier and capable of being hydrolyzed upon contact with water to yield boric acid or a salt thereof. The inventors reported that “attempts to employ other added organic compounds including acids, anhydrides, salts, oxides, molecular sieve adsorbents and active metal compounds” instead of such boron-containing compounds “were all unsuccessful.”

U.S. Pat. No. 6,376,250 B1 describes the incorporation of aluminum isopropoxide as a water scavenger in a visual indicating paste composition which includes a liquid carrier which is a high molecular weight polyol, a caustic powder selected from alkaline earth oxides, a gelling agent, a surfactant, a filler material, an indicator dye and a neutral dye.

Despite the aforementioned developments, there remains a need for alternative ways of effectively stabilizing water-indicating paste compositions against the detrimental effects of small amounts of moisture that such paste compositions may come into contact with as a result of their manufacture, their storage and/or their repeated exposure to ambient atmosphere as a result of the container in which they are stored being repeatedly opened over a period of time.

### SUMMARY OF THE INVENTION

Embodiments of the present invention provide a stabilized visual indicating paste which exhibits extended shelf life and improved water tolerance, while at the same time being characterized by low solubility in aqueous liquids and hydrocarbons, and good adhesion to substrates to which it is applied. Other aspects of the invention include methods of making such a stabilized visual indicating paste.

In other embodiments of the invention, a measuring probe is provided which has coated thereon a stabilized visual indicating composition which is useful for locating the level of aqueous liquids (e.g., liquids containing water or water in combination with oxygenated blending components such as alcohols and ethers) in the bottom of tanks and delivery systems containing hydrocarbons. Methods of utilizing such a probe to measure the level of such an aqueous liquid within a container are also provided.

It has now been discovered that paste compositions comprised of (i) an indicator dye capable of changing color in the pH range between about 3 and about 11, (ii) an inorganic base (which is typically dispersed in a liquid carrier based on one or more polyalkylene glycols) and (iii) optionally, a gelling agent, exhibit considerable improvement in shelf life and water tolerance when such paste compositions contain a relatively minor amount of one or more proton donating compounds having a pKa of not more than 12, as compared with pastes devoid of such proton donating compounds. This discovery was surprising, particularly in view of the teaching of U.S. Pat. No. 4,578,357 that attempts to use acids such as adipic acid and stearic acid to stabilize similar paste compositions against the detrimental effects of water were not successful.

### DETAILED DESCRIPTION OF EMBODIMENTS OF THE INVENTION

In accordance with the present invention, any proton donating compound having a pKa not greater than 12 or combination of such proton donating compounds is employable as a stabilizer in the paste compositions of the present invention. According to other embodiments, the pKa of the proton donating compound is not greater than 11, not greater than 10, not greater than 9 or not greater than 8. In other embodiments, it may be preferred for the pKa of the proton donating compound to be −3 or greater, −2 or greater, −1 or greater, or 0 or greater. For example, the pKa of the proton donating compound may be in the range of −3 to 12, −2 to 10 or 0 to 8. If the proton donating compound is capable of donating more than one proton (such as in the case of a dicarboxylic acid such as citric acid, for example), pKa as used herein refers to the lowest pKa value, i.e., pKa₁. The pKa of a compound is determinable by conventional methods known in the art and many different sources listing the pKa of known compounds are readily available.

In certain other embodiments of the invention, it may be advantageous for the proton donating compound or combination of such compounds to be fully miscible with or soluble in the liquid carrier (e.g., polyalkylene glycol) component of the paste composition.

According to certain aspects of the invention, the proton donating compound is at least partially water soluble. Preferably, however, the water solubility of the proton donating compound is limited (i.e., the proton donating compound is not freely soluble in water in all proportions). For example, the proton donating compound may have a solubility in water at 25° C. of at least 0.01 g/L or at least 0.05 g/L. In other examples, the proton donating compound may have a solubility in water at 25° C. of not more than 75 g/L or not more than 60 g/L.

The proton donating compound preferably is an organic compound, such as an organic acid. Suitable acids for purpose of the present invention include, but are not limited to, carboxylic acids (organic compounds containing one or more —CO₂H groups) and organosulfonic acids (organic compounds containing one or more —SO₃H groups). The organic acid may be an aliphatic organic acid (meaning that the acid functional group is substituted on an aliphatic carbon atom) or an aromatic organic acid (meaning that the acid functional group is substituted on an aromatic carbon atom). It is also possible to employ organic acids containing one or more aliphatic moieties and one or more aromatic moieties.

Examples of suitable proton donating compounds useful in the present invention include, but are not limited to, C4-C24 aliphatic carboxylic acids, including C6-C24 aliphatic monocarboxylic acids (which may be saturated or unsaturated and may be straight chain or branched or may contain one or more aliphatic ring structures) and C4-C8 aliphatic dicarboxylic acids (which may be saturated or unsaturated and may be straight chain or branched), and C6-C18 alkylated aryl sulfonic acids (i.e., compounds in which a C6-C18 alkyl group and a sulfonic acid group are attached to an aromatic ring such as a benzene ring), such as nonanoic acid, dodecylbenzenesulfonic acid, adipic acid, succinic acid and combinations thereof .

The proton donating compound or combination of proton donating compounds is employed in the paste composition in an amount sufficient to provide the desired level of stabilization or inhibition to moisture. At the same time, such amount should not be so great so as to interfere with the ability of the paste composition to turn color when used for its intended purpose in detecting an aqueous liquid within a desired period of time (typically, within less than a minute upon being contacted with such aqueous liquid at 25° C.). Thus, according to certain embodiments, the paste composition comprises an amount of the at least one proton donating compound which is effective to stabilize the paste composition against color change upon exposing the paste composition to air having a relative humidity of 70% at 25° C. for at least 10 minutes. In still further embodiments, the paste composition is comprised of an amount of the at least one proton donating compound which is effective to permit the paste composition to exhibit a color change within 1 minute or within 30 seconds of being contacted with pure water at 25° C. Both of the aforementioned criteria may be met in certain embodiments of the invention (i.e., the paste composition may comprise an amount of the at least one proton donating compound which is effective to both stabilize the paste composition against color change upon exposing the paste composition to air having a relative humidity of 70% at 25° C. for at least 10 minutes and to permit the paste composition to exhibit a color change within 1 minute or within 30 seconds of being contacted with pure water at 25° C.). In general, the proton donating compound(s) may be present in the paste composition of the invention in a concentration ranging from about 0.01 to about 5 percent, based on the total weight of the paste composition. The amount of proton donating compound(s) may be adjusted as appropriate based on the particular proton donating compound(s) selected, the pKa value(s) of the proton donating compound(s), and the type and amount of inorganic base, among other factors.

According to certain embodiments, the at least one first inorganic base and the at least one proton donating compound are present in amounts effective to provide a weight ratio of first inorganic base:proton donating compound of from 1:1 to 100:1. According to other embodiments, the at least one proton donating compound is present in the paste composition in stoichiometric excess relative to the total amount of water and second inorganic base which is present when the paste composition is prepared.

The stabilized visual indicating paste compositions of the present invention turn color, generally within about 60 second or less or about 30 seconds or less, and normally within about 5 to 15 seconds or less, depending upon the indicator dye employed, upon contact at 25° C. with water or an aqueous liquid, i.e., a liquid containing water, such as a water-containing oxygenated hydrocarbon. The oxygenated hydrocarbon may be selected from, for example, lower alcohols, illustratively methanol, ethanol, tertiary butyl alcohol, secondary butyl alcohol and mixtures thereof; lower polyols such as alkylene glycols, and lower ketones such as acetone and methyl tertiary butyl ether, and the like. The term “aqueous liquid” is employed herein to designate such substances having chemical characteristics similar to those of water, as distinguished from “oily liquid”, i.e. a fuel, petroleum or hydrocarbon oils and the like, which do not effect a change in color of the composition of the present invention. The aqueous liquids referred to hereinabove may contain up to about 95% of oxygenated hydrocarbon and are typically obtainable from the use of oxygenated blending components in hydrocarbons, such as gasoline, which are leached from the hydrocarbon into the water layer. According to certain embodiments, the aqueous liquid is in the form of a homogeneous liquid or solution wherein water is dissolved or solubilized in one or more non-water components such as an oxygenated blending component or wherein one or more non-water components are dissolved or solubilized in water.

The indicator dyes employed in the paste composition of the present invention preferably are water-soluble dyes, which are readily available from commercial sources as fine anhydrous crystalline powders. In general, the dye particles exhibit diameters not greater than about 200 microns. These dyes are characterized as being capable, upon contacting the paste composition with water, of effecting color change of the paste composition in the pH range between about 3 and about 11. Typically, the paste composition as initially formulated is characterized as having a first pH value and a first color as a result of the color of the indicator dye at the first pH value. When the paste composition is contacted with an aqueous liquid, water present in the aqueous liquid is believed to interact with the first inorganic base present in the paste composition (e.g., calcium oxide) to form a second inorganic base (e.g., calcium hydroxide) which is more basic than the first inorganic base. The formation of the second inorganic base results in an increase in the pH value; that is, the paste composition exhibits a second pH value that is higher than the first pH value. The second pH value is sufficiently greater than the first pH value so as to cause the indicator dye to change color. For example, the indicator dye may be colorless at the first pH value but blue or purple at the second (higher) pH value.

Such indicator dyes are normally employed as components of paste compositions in an amount sufficient to provide the desired color change. In general, such dyes may be employed in concentrations ranging from between about 0.05 and about 5, preferably between about 0.1 and about 3 percent, based on the total weight of the paste composition. Representative indicator dyes employable as constituents in the compositions of the invention include, but are not limited to: phenolphthalein, o-cresolphthalein, p-naphtholbenzein, ethyl bis(2,4-dinitrophenol) acetate, thymolphthalein, Nile Blue A, cresol red, bromophenol blue and thymol blue. The indicator dye used may be selected on the basis of its regulatory status and/or its toxicity characteristics.

The inorganic base employed as a constituent of the visual indicator paste compositions of the present invention must be one which does not dissolve and ionize in the liquid carrier to any significant extent, but is readily soluble in water (either directly or as result of reaction with water, as in the case of calcium oxide which reacts with water to form calcium hydroxide). According to embodiments of the invention, the inorganic base is present in the paste composition in finely divided particulate form, e.g., as a powder. According to certain embodiments of the invention, finely divided particles of the inorganic base may be dispersed in the liquid carrier. In general, anhydrous solid forms of an alkaline earth oxide, hydroxide, or mixtures thereof, or any compound which will generate an alkaline earth oxide or hydroxide in situ, e.g. an alkaline earth hydride, are suitable for use in the paste compositions of the present invention. These materials may be in the form of a finely divided technical grade crystalline powder and are readily available from commercial sources. Typical inorganic bases employable in accordance with the invention include calcium oxide, calcium hydroxide, strontium oxide, strontium hydroxide, barium oxide, barium hydroxide, magnesium oxide, magnesium hydroxide, and hydrides of these metals such as calcium hydride. Alkaline earth oxides such as calcium oxide (CaO) are especially suitable for use in the present invention.

The selection of the inorganic base will in part depend upon the particular indicator dye or combination of indicator dyes employed in formulating the paste composition. For example, the inorganic base may be chosen such that it imparts a pH to the paste composition as initially formulated at which the indicator dye also present in the paste composition is a first color (or colorless).

In general, the inorganic base is employed in a concentration ranging from about 1 to about 25 percent, preferably between about 5 and about 20 percent by weight of the paste composition, in order to provide the desirable water sensitivity properties characteristic of the paste compositions of the present invention.

As a vehicle for the paste composition of the invention, there is employed a liquid carrier which is capable of absorbing water, but is not readily leached by water or by the hydrocarbon(s) with which the paste composition will be contacted during its intended use. In this context, the term “liquid carrier” refers to a carrier that is liquid at 25° C. Any organic compound, or mixture thereof, exhibiting such characteristics which is inert to the other composition ingredients may be employed. Other desirable characteristics of the liquid carrier are that it have a sufficiently high viscosity for good paste consistency, have a low freezing point and not inhibit fairly rapid, i.e., within about 2 minutes or less, color reaction of the indicator dye, upon contact of the paste composition with aqueous liquids. Especially suitable liquid carriers employable include aliphatic polyols, alkylene glycols and polyalkylene glycols of sufficiently high molecular weight to preclude their solubility in the water/hydrocarbon environment in which the visual indicating paste composition is employed. In general, polyols, glycols, and mixtures thereof, having a number average molecular weight of at least about 75 g/mol are useful as liquid carriers in the composition of the present invention. Illustrative polyols employable in the composition of the invention include 1,4-butanediol; 1,3-butanediol; hexylene glycol; 1,2,6-hexanetriol; and 1,6-hexanediol. The polyalkylene glycols normally contain from between about 2 and 4 carbon atoms in each alkylene chain unit of the polyalkylene glycol (e.g., the alkylene chain units may be oxyethylene, oxypropylene and/or oxybutylene chain units). Illustrative polyalkylene glycols that are employable include polyethylene glycols, polypropylene glycols, polyethylene/propylene glycols (random or block) and polybutylene glycols having number average molecular weights (as determined by gel permeation chromatography) between about 200 and about 4000 g/mol. As is evident to those skilled in the art, such polyols and glycols are commercially available products and are employable either alone or as mixtures with or without other conventional liquid carriers, and, when employed as mixtures, are employed to obtain the optimum hydrophilic/hydrophobic balance. Combinations or mixtures of polypropylene glycols and polyethylene glycols are employed in certain embodiments of the invention. In general, the liquid carrier is employed in an amount of at least about 40 percent by weight, and generally between about 50 and about 90 percent by weight, based on the total weight of the paste composition. Polyalkylene glycols (in particular, polyethylene glycols and polypropylene glycols, including combinations thereof) of number average molecular weight between about 200 and 1500 g/mol, employed in an amount of between about 60 and 80 percent of the total weight of the paste composition, provide particularly desirable properties, and hence, are preferred for use in the composition of the invention.

If desired, a gelling agent or combination of gelling agents which serves as a thickener and/or color stabilizer, and which is inert to the other ingredients of the paste composition, may optionally be employed as an added constituent of the paste composition of the invention. The purpose for using such a gelling agent is to retard leaching and to gel the composition. Any known substance having a color other than that which would interfere with the visual detection provided by the paste composition of the invention in its application and which serves to provide the thickening properties and color stabilization indicated may be employed. Illustrative suitable gelling agents employed as components of the paste composition of the present invention include inert inorganic fillers or diluents such as talc, clay, diatomaceous earth, calcium silicate, silica, fumed colloidal silica, alumina, pyrophyllite, calcite, or mixtures of the same or other finely divided solid materials. In general, if employed the gelling agent is used in quantities up to about 20 percent by weight, or more, preferably between about 2 and about 15 percent by weight, based on the total weight of the paste composition.

The compositions of the present invention may be prepared by customary methods employed in the art for the production of paste compositions. In general, the components of the composition are conventionally fed to a mixer at ambient temperature and blended to an even, smooth paste, it being understood that blending at elevated temperatures or under other conditions conventionally employed for blending pastes may be employed. Incorporation of the ingredients of the composition is readily effected by incorporation of the components, individually or together, by grinding, dry-mixing, or blending into the liquid carrier. Hence, the inorganic base, indicator dye, proton donating compound and/or gelling agent, if employed, may be incorporated prior to, concurrently with, or after the incorporation of the other ingredients in the liquid carrier. Alternatively, prior to incorporation of the solid ingredients in the liquid carrier, the proton donating compound may be dissolved in the liquid carrier.

According to a preferred embodiment, the paste composition may be prepared by a method comprising combining:
a) at least one indicator dye capable of changing color in a pH range between about 3 and about 11;
b) at least one inorganic base capable of reacting with water to convert the first inorganic base into a second inorganic base which is more basic than the first inorganic base;
c) at least one liquid carrier;
d) optionally, at least one gelling agent; and
e) at least one proton donating compound having a pKa of at most 12, preferably at most 10, and more preferably at most 8.

In particular, such a method may comprise steps of:
a) combining the at least one liquid carrier, the at least one indicator dye and the at least one proton donating compound to obtain a first mixture;
b) combining the first mixture with the at least one inorganic base to obtain a second mixture; and
c) optionally (but preferably), combining the second mixture with the at least one gelling agent to obtain the paste composition.

Water is advantageously excluded during preparation of the paste composition. For example, the components of the paste composition may be anhydrous or essentially free of water. According to certain embodiments of the invention, certain of the components of the paste composition may be combined and dried to remove water or reduce the water content before adding the further components of the paste composition. For example, if multiple liquid carriers such as different polyalkylene glycols are to be used in formulating a paste composition, such liquid carriers may be combined and subjected to vacuum stripping while being heated to reduce the water content, with the remaining components (having satisfactorily low water content) then being added. Combining the components of the paste composition may be done under a dry atmosphere (e.g., dry nitrogen) in order to prevent absorption of atmospheric water into the paste composition. Once a paste composition in accordance with the present invention has been formulated, it may be transferred to a suitable sealable container that can be readily opened to permit dispensing of the paste composition and then re-sealed to protect the past composition from moisture exposure. Suitable sealable containers include, for example, capped tubes, bottles, pails and drums constructed of suitable materials such as plastic or metal.

It is to be understood that the paste composition of the present invention may additionally include adjuvants well-known to those skilled in the art, such as sticking agents, water scavengers and the like. As sticking agents, there may be employed materials such as casing gelatin, cellulose derivatives such as carboxymethyl cellulose, sulfite waste liquor, water-dispersible synthetic resins, mineral oil, or equivalent adhesives, all of which are well-known in the art.

The paste compositions of the present invention may additionally comprise one or more surfactants, such as nonionic surfactants (e.g., ethoxylated nonylphenol surfactants), typically in amounts up to about 5% by weight (e.g., 0.1% to 4% by weight) based on the total weight of the paste composition.

One or more fillers other than gelling agents may also be present in the paste composition. Calcium carbonate and gypsum are examples of suitable fillers.

The present invention provides readily utilizable stabilized paste compositions which are particularly adapted for locating the water level in tanks or other storage or delivery facilities for hydrocarbons which may be admixed with water, or with “aqueous liquids” as above defined. A particular application of the paste compositions of the present invention is found in measuring the level of water bottoms in gasoline storage tanks which must be monitored frequently to prevent the delivery of water into vehicle gasoline tanks. Water bottoms of storage or delivery facilities for gasoline containing oxygenated blending components, i.e. gasolines containing alcohols or ethers such as methanol, ethanol, tertiary butyl alcohol, methyl t-butyl ether, or mixtures thereof, may contain up to about 90 volume percent of alcohol.

A paste composition in accordance with the present invention may be utilized as follows to measure the level of an aqueous liquid that may be present in a container. Typically, if a hydrocarbon fuel such as gasoline has become contaminated with excess amounts of water, phase separation of the contents of a container, such as a tank, being used to store or hold the hydrocarbon fuel is observed wherein an aqueous liquid phase forms at the bottom of the container and a hydrocarbon phase (lower in density than the aqueous liquid phase) forms as a separate phase on top of the aqueous liquid phase. A quantity of a paste composition in accordance with the present invention may be placed as a layer (preferably, a thin, uniform layer) on at least one end of a measuring probe. The measuring probe may be elongated and of dimensions configured to reach to the bottom of the container while fitting through an opening at the top of the container. The measuring probe may be constructed of any suitable material, such as wood, metal or an engineering thermoplastic, which is resistant to the contents of the container. An end of the measuring probe having a layer of the paste composition positioned thereon may then be extended down through a container opening and the contents of the container until it reaches the bottom of the container. The measuring probe is kept in contact with the container contents for a time effective to achieve a color change in the paste composition if the paste composition comes into contact with an aqueous liquid (typically, a period of time of up to 1 or 2 minutes), then withdrawn from the container and visually inspected for any color change. As the paste composition will visibly turn color only where it has come into contact with water in the form of an aqueous liquid, the presence and depth of any aqueous phase which has formed in the container may be readily ascertained. Remedial action may thereafter be taken should such an aqueous phase be detected, such as siphoning out the aqueous phase or draining and cleaning the container.

Illustrative, non-limiting aspects of the present invention may be summarized as follows:

Aspect 1: A paste composition for producing a detectable color change upon contact with an aqueous liquid, comprising:
a) at least one indicator dye capable of changing color in a pH range between about 3 and about 11;
b) at least one first inorganic base capable of reacting with water to convert the first inorganic base into a second inorganic base which is more basic than the first inorganic base;
c) at least one liquid carrier;
d) optionally, at least one gelling agent; and
e) at least one proton donating compound having a pKa of at most 12, preferably at most 10, and more preferably at most 8.

Aspect 2: The paste composition of Aspect 1, herein the at least one proton donating compound comprises at least one organic acid.

Aspect 3: The paste composition of Aspect 1 or 2, wherein the at least one proton donating compound comprises at least one organic acid selected from the group consisting of carboxylic acids, organosulfonic acids, and combinations thereof.

Aspect 4: The paste composition of any of Aspecst 1-3, wherein the at least one proton donating compound comprises at least one organic acid selected from the group consisting of C6-C24 aliphatic carboxylic acids, C6-C18 alkylated aryl sulfonic acids, and combinations thereof.

Aspect 5: The paste composition of any of Aspecst 1-4, wherein the at least one proton donating compound comprises at least one organic acid selected from the group consisting of nonanoic acid, dodecylbenzene sulfonic acid, and combinations thereof.

Aspect 6: The paste composition of any of Aspecst 1-5, wherein the at least proton donating compound comprises at least one proton donating compound having a solubility in water at 25° C. of from 0.01 g/L to 75 g/L.

Aspect 7: The paste composition of any of Aspecst 1-6, wherein the at least one proton donating compound has a pKa of at least zero.

Aspect 8: The paste composition of any of Aspecst 1-7, wherein the at least one proton donating compound is present in stoichiometric excess relative to the total amount of water and second inorganic base which is present when the paste composition is prepared.

Aspect 9: The paste composition of any of Aspecst 1-8, comprising an amount of the at least one proton donating compound which is effective to stabilize the paste composition against color change upon exposing the paste composition to air having a relative humidity of 70% at 25° C. for at least 10 minutes.

Aspect 10: The paste composition of any of Aspecst 1-9, comprising an amount of the at least one proton donating compound which is effective to permit the paste composition to exhibit a color change within 1 minute of being contacted with water at 25° C.

Aspect 11: The paste composition of any of Aspecst 1-10, comprising from about 0.01 to about 5 percent by weight in total of the at least one proton donating compound.

Aspect 12: The paste composition of any of Aspecst 1-11, wherein the at least one first inorganic base and the at least one proton donating compound are present in amounts effective to provide a weight ratio of first inorganic base : proton donating compound of from 1:1 to 100:1.

Aspect 13: The paste composition of any of Aspecst 1-12, wherein the at least one indicator dye comprises at least one indicator dye that is water soluble.

Aspect 14: The paste composition of any of Aspecst 1-13, wherein the at least one indicator dye comprises at least one indicator dye selected from the group consisting of o-cresolphthalein, phenolphthalein, p-naphtholbenzein, ethyl bis(2,4-dinitrophenol) acetate, thymolphthalein, Nile Blue A, cresol red, bromophenol blue, and thymol blue.

Aspect 15: The paste composition of any of Aspecst 1-14, wherein the at least one first inorganic base includes CaO.

Aspect 16: The paste composition of any of Aspecst 1-15, wherein the at least one liquid carrier includes at least one polyalkylene glycol.

Aspect 17: A method of making a paste composition for producing a detectable color change upon contact with an aqueous liquid, comprising combining:
a) at least one indicator dye capable of changing color in a pH range between about 3 and about 11;
b) at least one inorganic base capable of reacting with water to convert the first inorganic base into a second inorganic base which is more basic than the first inorganic base;
c) at least one liquid carrier;
d) optionally, at least one gelling agent; and
e) at least one proton donating compound having a pKa of at most 12, preferably at most 10, and more preferably at most 8.

Aspect 18: The method of Aspect 17, comprising steps of:
a) combining the at least one polyalkylene glycol, the at least one indicator dye and the at least one proton donating compound to obtain a first mixture;
b) combining the first mixture with the at least one inorganic base to obtain a second mixture; and
c) optionally, combining the second mixture with the at least one gelling agent to obtain the paste composition.

Aspect 19: The method of Aspect 17 or 18, wherein the at least one proton donating compound comprises at least one organic acid.

Aspect 20: The method of any of Aspecst 17-19, wherein the at least one proton donating compound comprises at least one organic acid selected from the group consisting of carboxylic acids, organosulfonic acids, and combinations thereof.

Aspect 21: The method of any of Aspecst 17-20, wherein the at least one proton donating compound comprises at least one organic acid selected from the group consisting of C6-C24 aliphatic carboxylic acids, C6-C18 alkylated aryl sulfonic acids, and combinations thereof.

Aspect 22: The method of any of Aspecst 17-21, wherein the at least one proton donating compound comprises at least one organic acid selected from the group consisting of nonanoic acid, dodecylbenzene sulfonic acid, and combinations thereof.

Aspect 23: The method of any of Aspecst 17-22, wherein the at least proton donating compound comprises at least one proton donating compound having a solubility in water at 25° C. of from 0.01 g/L to 75 g/L.

Aspect 24: The method of any of Aspecst 17-23, wherein the at least one proton donating compound has a pKa of at least zero.

Aspect 25: The method of any of Aspecst 17-24, wherein an amount of the at least one proton donating compound is employed which is in stoichiometric excess relative to the total amount of water and second inorganic base which is present when the paste composition is prepared.

Aspect 26: The method of any of Aspecst 17-25, wherein an amount of the at least one proton donating compound is employed which is effective to stabilize the paste composition against color change upon exposing the paste composition to air having a relative humidity of 70% at 25° C. for at least 10 minutes.

Aspect 27: The method of any of Aspecst 17-26, wherein an amount of the at least one proton donating compound is employed which is effective to permit the paste composition to exhibit a color change within 1 minute of being contacted with water at 25° C.

Aspect 28: The method of any of Aspecst 17-27, wherein the paste composition comprises from about 0.01 to about 2 percent by weight in total of the at least one proton donating compound.

Aspect 29: The method of any of Aspecst 17-28, wherein the at least one indicator dye comprises at least one indicator dye that is water soluble.

Aspect 30: The method of any of Aspecst 17-29, wherein the at least one indicator dye comprises at least one indicator dye selected from the group consisting of o-cresolphthalein, phenolphthalein, p-naphtholbenzein, ethyl bis(2,4-dinitrophenol) acetate, thymolphthalein, Nile Blue A, cresol red, bromophenol blue, and thymol blue.

Aspect 31: A paste composition obtained by the method of any of Aspecst 18 to 30.

Aspect 32: A method of detecting an aqueous liquid within a container having contents disposed therein, wherein the method comprises contacting a measuring probe having disposed thereon a layer of a paste composition in accordance with any of Aspecst 1 to 16 or 31 with the contents of the container, withdrawing the measuring probe from the container, and visually inspecting the layer of the paste composition for a color change resulting from interaction of the paste composition with the aqueous liquid.

### EXAMPLES

### Example 1

Added 26.5 g polypropylene glycol (molecular weight=750 g/mol), 26.5 g polypropylene glycol (molecular weight=1025 g/mol) and 31.6 g polyethylene glycol (molecular weight=400 g/mol) to a round bottom flask equipped with agitator, heating mantle and temperature controller, nitrogen purge and vacuum. Heated to 65° C. and applied full vacuum to reduce water content to <300 ppm. Stopped vacuum and added 2.0 g o-cresolphthalein and 1.0 g of dodecylbenzene sulfonic acid. Agitated at 65° C. until the solids dissolved. Added 7.0 g calcium oxide and dispersed. Slowly added 6.0 g Cab-O-Sil® M5 fumed silica and agitated to form a paste. The paste was an off-white color. When applied to a wooden stick and immersed in E10 gasoline containing 1 phr water, the paste in contact with the aqueous layer turned light purple in 2 seconds and deep purple in 15 seconds.

### Example 2

Added 26.5 g polypropylene glycol (molecular weight=750 g/mol), 26.5 g polypropylene glycol (molecular weight=1025 g/mol) and 31.6 g polyethylene glycol (molecular weight=400 g/mol) to a round bottom flask equipped with agitator, heating mantle and temperature controller, nitrogen purge and vacuum. Heated to 65° C. and applied full vacuum to reduce water content to <300 ppm. Stopped vacuum and added 0.425 g thymol blue and 0.085 g of nonanoic acid. Agitated at 65° C. until the solids dissolved. Added 7.0 g calcium oxide and dispersed. Slowly added 8.0 g Cab-O-Sil® M5 fumed silica and agitated to form a paste. The paste was an orange color. When applied to a wooden stick and immersed in E10 gasoline containing 1 phr water, the paste in contact with the aqueous layer turned faint blue in 12 seconds and deep blue in 25 seconds. Although the paste stored in a sealed sample container turned green in 30 days, the shelf-life of such a composition is expected to be much longer when the composition s prepared on a larger, commercial scale under conditions in which moisture can be more rigorously excluded.

### Example 3

Added 26.5 g polypropylene glycol (molecular weight=750 g/mol), 26.5 g polypropylene glycol (molecular weight=1025 g/mol) and 31.6 g polyethylene glycol (molecular weight=400 g/mol) to a round bottom flask equipped with agitator, heating mantle and temperature controller, nitrogen purge and vacuum. Heated to 65° C. and applied full vacuum to reduce water content to <300 ppm. Stopped vacuum and added 0.5 gm thymol blue and 0.44 g of adipic acid. Agitated at 65° C. until the solids dissolved. Added 7.0 g calcium oxide and dispersed. Slowly added 6.0 g Cab-O-Sil® M5 fumed silica and agitated to form a paste. The paste was an orange color. When applied to a wooden stick and immersed in E10 gasoline containing 1 phr water, the paste in contact with the aqueous layer turned faint blue in 2 seconds.

### Example 4

Added 26.5 g polypropylene glycol (molecular weight=750 g/mol), 26.5 g polypropylene glycol (molecular weight=1025 g/mol) and 31.6 g polyethylene glycol (molecular weight=400 g/mol) to a round bottom flask equipped with agitator, heating mantle and temperature controller, nitrogen purge and vacuum. Heated to 65° C. and applied full vacuum to reduce water content to <300 ppm. Stopped vacuum and added 0.5 gm thymol blue and 0.36 g of succinic acid. Agitated at 65° C. until the solids dissolved. Added 7.0 g calcium oxide and dispersed. Slowly added 6.0 g Cab-O-Sil® M5 fumed silica and agitated to form a paste. The paste was an orange color. When applied to a wooden stick and immersed in E10 gasoline containing 1 phr water, the paste in contact with the aqueous layer turned faint blue in 2 seconds.

### Example 5

Added 26.5 g polypropylene glycol (molecular weight=750 g/mol), 26.5 g polypropylene glycol (molecular weight=1025 g/mol) and 31.6 g polyethylene glycol (molecular weight=400 g/mol) to a round bottom flask equipped with agitator, heating mantle and temperature controller, nitrogen purge and vacuum. Heated to 65° C. and applied full vacuum to reduce water content to <300 ppm. Stopped vacuum and added 1.0 gm thymolphthalein and 1.0 gm of dodecylbenzene sulfonic acid. Agitated at 65° C. until the solids dissolved. Added 7.0 g calcium oxide and dispersed. Slowly added 6.0 g Cab-O-Sil® M5 fumed silica and agitated to form a paste. The paste was an off-white color. When applied to a wooden stick and immersed in E10 gasoline containing 1 phr water, the paste in contact with the aqueous layer turned faint blue in 15 seconds and deep blue in 60 seconds.

### Example 6

Added 26.5 g polypropylene glycol (molecular weight=750 g/mol), 26.5 g polypropylene glycol (molecular weight=1025) and 31.6 g polyethylene glycol (molecular weight=400 g/mol) to a round bottom flask equipped with agitator, heating mantle and temperature controller, nitrogen purge and vacuum. Heated to 65° C. and applied full vacuum to reduce water content <300 ppm. Stopped vacuum and added 0.25 g cresol red and 2.0 gm of dodecylbenzene sulfonic acid. Agitate at 65° C. until the solids dissolved. Added 7.0 g calcium oxide and dispersed. Slowly added 6.0 g Cab-O-Sil® M5 fumed silica and agitated to form a paste. The paste was a brown color. When applied to a wooden stick and immersed in E10 gasoline containing 1 phr water, the paste in contact with the aqueous layer turned faint purple in 5 seconds and deep purple in 15 seconds.

### Example 7

Added 26.5 g polypropylene glycol (molecular weight=750 g/mol), 26.5 g polypropylene glycol (molecular weight=1025 g/mol) and 31.6 g polyethylene glycol (molecular weight=400 g/mol) to a round bottom flask equipped with agitator, heating mantle and temperature controller, nitrogen purge and vacuum. Heated to 65° C. and applied full vacuum to reduce water content to <300 ppm. Stopped vacuum and added 0.2 g bromophenol blue and 5.0 gm of dodecylbenzene sulfonic acid. Agitated at 65° C. until the solids dissolved. Added 7.0 g calcium oxide and dispersed. Slowly added 6.0 g Cab-O-Sil® M5 fumed silica and agitated to form a paste. The paste was a brown color. When applied to a wooden stick and immersed in E10 gasoline containing 1 phr water, the paste in contact with the aqueous layer turned faint blue in 2 seconds and deep blue in 10 seconds.

### Example 8 (Comparative)

Added 26.5 g polypropylene glycol (molecular weight=750 g/mol), 26.5 g polypropylene glycol (molecular weight=1025 g/mol) and 31.6 g polyethylene glycol (molecular weight=400 g/mol) to a round bottom flask equipped with agitator, heating mantle and temperature controller, nitrogen purge and vacuum. Heated to 65° C. and applied full vacuum to reduce water content to <300 ppm. Stopped vacuum and added 0.86 g thymol blue and 0.085 g of tripropyl borate. Agitated at 65° C. until the solids dissolved. Added 7.0 g calcium oxide and dispersed. Slowly added 8.0 g Cab-O-Sil® M5 fumed silica and agitated to form a paste. The paste was a deep orange color. When applied to a wooden stick and immersed in E10 gasoline containing 1 phr water, the paste in contact with the aqueous layer turned faint blue in 10 seconds and deep blue in 20 seconds and black spots formed on the paste where the paste was in contact the hydrocarbon layer above the aqueous layer. The paste in the sealed sample container turned blue in one day.

This example demonstrates the beneficial effects of including a proton donating compound in the paste composition in accordance with the present invention. The paste composition of Example 8, which contained tripropyl borate (a stabilizer taught in the prior art), but not a proton donating compound. A much shorter shelf life was observed as compared to the paste composition of Example 2, which had a composition similar to that of Example 8 except for the inclusion of nonanoic acid rather than tripropyl borate.

1. A paste composition for producing a detectable color change upon contact with an aqueous liquid, comprising:
a) at least one indicator dye capable of changing color in a pH range between about 3 and about 11;
b) at least one first inorganic base capable of reacting with water to convert the first inorganic base into a second inorganic base which is more basic than the first inorganic base;
c) at least one liquid carrier;
d) optionally, at least one gelling agent; and
e) at least one proton donating compound having a pKa of at most 12.

2. The paste composition of claim 1, wherein the at least one proton donating compound comprises at least one organic acid.

3. The paste composition of claim 1, wherein the at least one proton donating compound comprises at least one organic acid selected from the group consisting of carboxylic acids, organosulfonic acids, and combinations thereof.

4. The paste composition of claim 1, wherein the at least one proton donating compound comprises at least one organic acid selected from the group consisting of C6-C24 aliphatic carboxylic acids, C6-C18 alkylated aryl sulfonic acids, and combinations thereof.

5. The paste composition of claim 1, wherein the at least one proton donating compound comprises at least one organic acid selected from the group consisting of nonanoic acid, dodecylbenzene sulfonic acid, and combinations thereof.

6. The paste composition of claim 1, wherein the at least proton donating compound comprises at least one proton donating compound having a solubility in water at 25° C. of from 0.01 g/L to 75 g/L.

7. The paste composition of claim 1, wherein the at least one proton donating compound has a pKa of at least zero.

8. The paste composition of claim 1, wherein the at least one proton donating compound is present in stoichiometric excess relative to the total amount of water and second inorganic base which is present when the paste composition is prepared.

9. The paste composition of claim 1, comprising an amount of the at least one proton donating compound which is effective to stabilize the paste composition against color change upon exposing the paste composition to air having a relative humidity of 70% at 25° C. for at least 10 minutes.

10. The paste composition of claim 1, comprising an amount of the at least one proton donating compound which is effective to permit the paste composition to exhibit a color change within 1 minute of being contacted with water at 25° C.

11. The paste composition of claim 1, comprising from about 0.01 to about 5 percent by weight in total of the at least one proton donating compound.

12. The paste composition of claim 1, wherein the at least one first inorganic base and the at least one proton donating compound are present in amounts effective to provide a weight ratio of first inorganic base:proton donating compound of from 1:1 to 100:1.

13. The paste composition of claim 1, wherein the at least one indicator dye comprises at least one indicator dye that is water soluble.

14. The paste composition of claim 1, wherein the at least one indicator dye comprises at least one indicator dye selected from the group consisting of o-cresolphthalein, phenolphthalein, p-naphtholbenzein, ethyl bis(2,4-dinitrophenol) acetate, thymolphthalein, Nile Blue A, cresol red, bromophenol blue, and thymol blue.

15. The paste composition of claim 1, wherein the at least one first inorganic base includes CaO.

16. The paste composition of claim 1, wherein the at least one liquid carrier includes at least one polyalkylene glycol.

17. A method of making a paste composition for producing a detectable color change upon contact with an aqueous liquid, comprising combining:
a) at least one indicator dye capable of changing color in a pH range between about 3 and about 11;
b) at least one inorganic base capable of reacting with water to convert the first inorganic base into a second inorganic base which is more basic than the first inorganic base;
c) at least one liquid carrier;
d) optionally, at least one gelling agent; and
e) at least one proton donating compound having a pKa of at most 12.

18. The method of claim 17, comprising steps of:
a) combining the at least one polyalkylene glycol, the at least one indicator dye and the at least one proton donating compound to obtain a first mixture;
b) combining the first mixture with the at least one inorganic base to obtain a second mixture; and
c) optionally, combining the second mixture with the at least one gelling agent to obtain the paste composition.

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. A paste composition obtained by the method of claim 17.

32. A method of detecting an aqueous liquid within a container having contents disposed therein, wherein the method comprises contacting a measuring probe having disposed thereon a layer of a paste composition in accordance with claim 1 with the contents of the container, withdrawing the measuring probe from the container, and visually inspecting the layer of the paste composition for a color change resulting from interaction of the paste composition with the aqueous liquid.
